(19) United States
(12) Patent Application Publication
(10) Pub. No.: US 2025/0330348 A1
(43) Pub. Date: Oct. 23, 2025

(54) METHOD AND APPARATUS FOR SCRAMBLING PROCESSING, METHOD AND APPARATUS FOR TRANSMISSION PROCESSING, AND DEVICE

(71) Applicant: VIVO MOBILE COMMUNICATION CO., LTD., Guangdong (CN)

(72) Inventors: Jian YAO, Guangdong (CN); Dajie JIANG, Guangdong (CN)

(73) Assignee: VIVO MOBILE COMMUNICATION CO., LTD., Guangdong (CN)

(21) Appl. No.: 19/252,457

(22) Filed: Jun. 27, 2025

Related U.S. Application Data
(63) Continuation of application No. PCT/CN2023/142215, filed on Dec. 27, 2023.

(30) Foreign Application Priority Data
Dec. 30, 2022 (CN) 202211740066.5

(51) Int. Cl. H04L 25/03; H04L 5/00

(52) U.S. Cl. CPC H04L 25/03866; H04L 5/0048

(57) ABSTRACT

Disclosed are a method and apparatus for scrambling processing, a method and apparatus for transmission processing, and a device. The method for scrambling processing of embodiments of the present disclosure includes: obtaining, by a first device, a scrambling sequence according to a first information, where the first information is sensing-related information; scrambling, by the first device, a first signal according to the scrambling sequence, and obtaining a second signal; and transmitting the second signal by the first device.

### CROSS-REFERENCE TO RELATED APPLICATIONS

The present disclosure is a continuation application of PCT International Application No. PCT/CN2023/142215 filed on Dec. 27, 2023, which claims priority to Chinese Patent Application No. 202211740066.5 filed on Dec. 30, 2022, which is incorporated herein by reference in its entirety.

### TECHNICAL FIELD

The present disclosure belongs to the technical field of communication, and particularly relates to a method and apparatus for scrambling processing, a method and apparatus for transmission processing, and a device.

### BACKGROUND

In addition to a communication capability, a mobile communication system in the future will have a sensing capability. One or more devices having a sensing capability can sense information about a target object such as an orientation, a distance, and a speed, or detect, track, identify, and image a target object, an event, an environment, etc. by transmitting and receiving a radio signal.

In addition, in a communication system, data and a signal of related channels are generally scrambled to ensure reliability of transmission. However, in an existing signal scrambling solution for the communication system, only a communication function is considered. After a sensing function is introduced, how to scramble a signal has become an urgent problem to be solved.

### SUMMARY

A first aspect provides a method for scrambling processing. The method includes:
obtaining, by a first device, a scrambling sequence according to a first information, where the first information is sensing-related information;
scrambling, by the first device, a first signal according to the scrambling sequence, and obtaining a second signal; and
transmitting the second signal by the first device.

A second aspect provides an apparatus for scrambling processing. The apparatus includes:
a first processing module configured to obtain a scrambling sequence according to a first information, where the first information is sensing-related information;
a second processing module configured to scramble a first signal according to the scrambling sequence, and obtain a second signal; and
a first transmission module configured to transmit the second signal.

A third aspect provides a method for transmission processing. The method includes:
receiving a third signal by a second device.

The third signal is a second signal transmitted via a channel. The second signal is obtained by scrambling a first signal based on a scrambling sequence. The scrambling sequence is associated with a first information. The first information is sensing-related information.

A fourth aspect provides an apparatus for transmission processing. The apparatus includes:
a first reception module configured to receive a third signal.

The third signal is a second signal transmitted via a channel. The second signal is obtained by scrambling a first signal based on a scrambling sequence. The scrambling sequence is associated with a first information. The first information is sensing-related information.

A fifth aspect provides a communication device. The communication device includes a processor and a memory. The memory stores programs or instructions runnable on the processor. When the programs or the instructions are executed by the processor, steps of the method according to the first aspect or the method according to the third aspect are implemented.

A sixth aspect provides a communication device. The communication device includes a processor and a communication interface. The processor is configured to obtain a scrambling sequence according to a first information, where the first information is sensing-related information; and scramble a first signal according to the scrambling sequence, and obtain a second signal; and the communication interface is configured to transmit the second signal.

A seventh aspect provides a communication device. The communication device includes a processor and a communication interface. The communication interface is configured to receive a third signal. The third signal is a second signal transmitted via a channel. The second signal is obtained by scrambling a first signal based on a scrambling sequence. The scrambling sequence is associated with a first information. The first information is sensing-related information.

An eighth aspect provides a communication system. The communication system includes: a first device and a second device. The first device may be configured to execute steps of the method for scrambling processing according to the first aspect. The second device may be configured to execute steps of the method for transmission processing according to the third aspect.

A ninth aspect provides a readable storage medium. The readable storage medium stores programs or instructions. When the programs or the instructions are executed by a processor, steps of the method according to the first aspect or the method according to the third aspect are implemented.

A tenth aspect provides a chip. The chip includes a processor and a communication interface. The communication interface is coupled to the processor. The processor is configured to run programs or instructions, such that the method according to the first aspect or the third aspect is implemented.

An eleventh aspect provides a computer program/program product. The computer program/program product is stored in a storage medium. The computer program/program product is executed by at least one processor, such that steps of the method according to the first aspect or the method according to the third aspect are implemented.

### BRIEF DESCRIPTION OF THE DRAWINGS

FIG. 1 is a block diagram of a radio communication system;

FIG. 2 is a schematic diagram of a method for scrambling processing according to an embodiment of the present disclosure;

FIG. 3 is a first schematic diagram of division of a sensing zone;

FIG. 4 is a second schematic diagram of division of a sensing zone;

FIG. 5 is a schematic diagram of a method for transmission processing according to an embodiment of the present disclosure;

FIG. 6 is a schematic block diagram of an apparatus for scrambling processing according to an embodiment of the present disclosure;

FIG. 7 is a schematic block diagram of an apparatus for transmission processing according to an embodiment of the present disclosure;

FIG. 8 is a schematic structural diagram of a communication device according to an embodiment of the present disclosure;

FIG. 9 is a schematic structural diagram of a terminal according to an embodiment of the present disclosure; and

FIG. 10 is a schematic structural diagram of a network side device according to an embodiment of the present disclosure.

### DETAILED DESCRIPTION

Technical solutions in embodiments of the present disclosure will be clearly described below with reference to accompanying drawings in the embodiments of the present disclosure. Obviously, the embodiments described are some embodiments rather than all embodiments of the present disclosure. Based on the embodiments of the present disclosure, all other embodiments obtained by those of ordinary skill in the art should fall within the protection scope of the present disclosure.

In the description and claims of the present disclosure, terms such as “first” and “second” are intended to distinguish between similar objects but are not used for indicating a specific order or sequence. It should be understood that terms used in this way can be interchanged under appropriate circumstances, such that the embodiments of the present disclosure can be implemented in a sequence other than those illustrated or described herein. In addition, the objects distinguished by “first” or “second” are generally objects of a same type, and a number of objects is not restricted. For example, one or more first objects may exist. In addition, “and/or” in the description and the claims represents at least one of connected objects, and the character “/” generally represents an “or” relation between two associated context objects.

It is worth pointing out that the technology described in the embodiments of the present disclosure is not restricted to a long term evolution (LTE)/LTE-advanced (LTE-A) system, and can alternatively be used in other radio communication systems, such as code division multiple access (CDMA), time division multiple access (TDMA), frequency division multiple access (FDMA), orthogonal frequency division multiple access (OFDMA), single-carrier frequency division multiple access (SC-FDMA), and other systems. The terms “system” and “network” in the embodiments of the present disclosure are generally used interchangeably, and the described technology can be applied to the systems and radio technologies described above, or applied to other systems and radio technologies. The following description describes a new radio (NR) system for illustration. NR terms are used in most of the following description, but the technologies can be applied to applications other than NR system applications, such as a 6^{th} generation (6G) communication system.

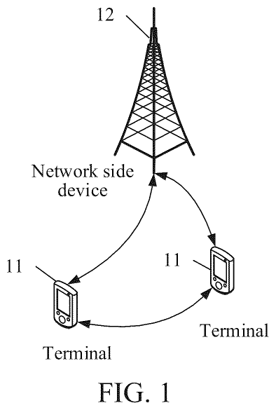

FIG. 1 shows a block diagram of a radio communication system applied to an embodiment of the present disclosure. The radio communication system includes a terminal 11 and a network side device 12. The terminal 11 may be a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home appliance (home equipment having a radio communication function, such as a refrigerator, a television, a washing machine or a furniture), and terminal side devices such as a game machine, a personal computer (PC), a teller machine or a self-service machine. The wearable device includes: a smart watch, a smart band, a smart headset, smart glasses, smart jewelry (a smart bracelet, a smart chain bracelet, a smart ring, a smart necklace, a smart anklet, a smart ankle chain, etc.), a smart wrist strap, a smart garment, etc. It should be noted that a specific type of the terminal 11 is not restricted by the embodiment of the present disclosure. The network side device 12 may include an access network device or a core network device. The access network device may alternatively be referred to as a radio access network device, a radio access network (RAN), a radio access network function, or a radio access network unit. The access network device may include a base station, a wireless local area network (WLAN) access point, a wireless fidelity (WiFi) node, etc. The base station may be referred to as a node B, an evolution node B (Evolved Node B, eNB), an access point, a base transceiver station (BTS), a radio base station, a radio transceiver, a basic service set (BSS), an extended service set (ESS), a home B node, a home evolution type B node, a transmission reception point (TRP), or any other suitable term in the art, as long as same technical effects are achieved. The base station is not limited to a particular technical vocabulary. It should be noted that in the embodiment of the disclosure, only a base station in an NR system is described as an example, and a specific type of the base station is not limited.

For convenience of understanding, some contents involved in the embodiments of the present disclosure will be described below.

First, integrated sensing and communication:

In addition to a communication capability, future mobile communication systems such as a beyond 5^{th} generation (B5G) communication system or a sixth generation (6G) communication system have a sensing capability. One or more devices having a sensing capability can sense information about a target object such as an orientation, a distance, and a speed, or detect, track, identify, and image a target object, an event, an environment, etc. by transmitting and receiving a radio signal. In the future, with deployment of small base stations having high frequency bands and large bandwidths such as millimeter wave and terahertz in 6G networks, sensing resolution will be significantly improved compared with centimeter wave, such that the 6G networks can provide more detailed sensing services. Typical sensing functions and application scenes are shown in Table 1.

TABLE 1

| Sensing function | Application scene |
|---|---|
| Weather condition, air | Meteorology, agriculture, and |
| quality, etc. | living service |
| Traffic flow (junction) and | Intelligent transportation and |
| pedestrian flow (subway | commercial service |
| entrance) | |
| Target tracking, ranging, | Numerous application scenes of |
| speed measurement, outline, | conventional radar |
| etc. | |
| Environmental reconfiguration | Intelligent driving and navigation |
| | (cars/drones), smart cities (3D maps), |
| | and network planning and optimization |
| Action/posture/expression | Intelligent interaction, gaming, and |
| identification | smart home through smart phones |
| Heartbeat/respiration, etc. | Health and medical care |
| Imaging, material detection, | Security check, industry, biomedicine, |
| composition analysis, etc. | etc. |

Integrated sensing and communication means that in a same system, a design of integrated sensing and communication functions is implemented through spectrum sharing and hardware sharing. When information is transmitted, the system can sense information such as an orientation, a distance, and a speed, and detect, track, and identify a target device or an event. A communication system and a sensing system cooperate with each other, to improve overall performance and bring better service experience.

Integrated communication and radar is a typical application of integrated sensing and communication (integration of communication and sensing). In the past, a radar system and a communication system are strictly distinguished because of different research objects and focuses, and the two systems are studied independently in most scenes. In fact, the radar system and the communication system are typical ways of information transmission, obtaining, processing, and exchange, and have many similarities in working principle, system architecture, and frequency band. The design of integrated communication and radar has great feasibility, which is mainly reflected in the following aspects: First, both a communication system and a sensing system are based on an electromagnetic wave theory, and information is obtained and transferred by transmitting and receiving an electromagnetic wave. Then, both the communication system and the sensing system have an antenna, a transmission end, a reception end, a signal processor, and other structures, and there is great overlap in hardware resources. With the development of technology, there is more and more overlap between the communication system and the sensing system in an operating band. There are similarities in key technologies such as signal modulation, reception detection, and waveform design. The integration of the communication system and the radar system can bring many advantages, such as cost saving, size reduction, power consumption reduction, an increase in spectrum efficiency, and reduction in mutual interference, thereby enhancing overall system performance.

According to different transmission nodes and reception nodes of a sensing signal, there are six types of sensing links. It is worth noting that with a case that each sensing link has one transmission node and one reception node as an example, in actual systems, different sensing links may be selected according to different sensing needs. Each sensing link may have one or more transmission nodes and reception nodes, and an actual sensing system may include a variety of different sensing links. With sensing objects as persons and vehicles as an example, sensing objects of the actual systems are more diversified.

1) Self-transmitting and self-receiving sensing of a base station. In this way, the base station transmits a sensing signal and obtains a sensing result by receiving echoes of the sensing signal.

2) Radio sensing of a base station. In this case, a base station 2 receives a sensing signal transmitted by a base station 1 and obtains a sensing result.

3) Uplink radio sensing. In this case, a base station receives a sensing signal transmitted by user equipment (UE, referred to as a terminal), and obtains a sensing result.

4) Downlink radio sensing. In this case, UE receives a sensing signal transmitted by a base station and obtains a sensing result.

5) Self-transmitting and self-receiving sensing of a terminal. In this case, UE transmits a sensing signal and obtains a sensing result by receiving an echo of the sensing signal.

6) Inter-terminal sidelink sensing. For example, UE 2 receives a sensing signal transmitted by UE 1 and obtains a sensing result.

Second, signal scrambling in a communication system:

To ensure reliability of communication transmission, a transmitted signal needs to be scrambled, and a scrambling sequence is generally a pseudorandom sequence. During signal scrambling, scrambling initialization needs to be first performed. A process of the scrambling initialization may be understood as a process of generating an initial value of the scrambling sequence, and then the signal is scrambled through the scrambling sequence generated according to the initial value of the scrambling sequence.

A method and apparatus for scrambling processing, a method and apparatus for transmission processing, and a device according to the embodiments of the present disclosure will be described in detail below through some embodiments and their application scenes with reference to the accompanying drawings.

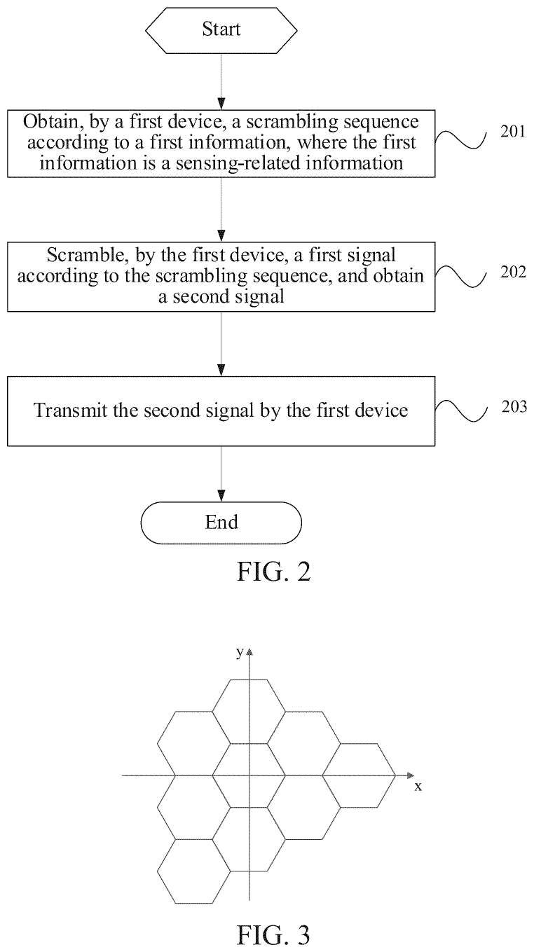

As shown in FIG. 2, the method for scrambling processing according to the embodiments of the present disclosure includes the following steps:

Step 201, a first device obtains a scrambling sequence according to a first information. The first information is sensing-related information.

In the step, the first device may generate the scrambling sequence according to the sensing-related information, and associate scrambling and sensing of a signal.

Step 202, the first device scrambles a first signal according to the scrambling sequence, and obtains a second signal.

In the step, the first device scrambles the first signal through the scrambling sequence obtained in step 201.

Step 203, the first device transmits the second signal.

In the step, the first device transmits the second signal obtained through scrambling in step 202. Herein, the second signal is used for sensing measurement, or is used for sensing measurement and communication.

In this way, through the steps 201 to 203, the first device generates the scrambling sequence according to the sensing-related information, then scrambles the first signal according to the scrambling sequence to obtain the second signal, and transmits the second signal. In this way, not only sensing-oriented interference is randomly distributed, but also the sensing-related information is carried by the second signal. Thus, a reception end may obtain the sensing-related information through detection, and signaling overhead may be reduced.

Optionally, in the embodiment, the first information includes at least one of the following:
a sensing zone identity;
an identity indicating whether to be used for sensing;
a sensing service identity;
a sensing service type identity;
a sensing target identity;
a tag identity associated with a sensing target;
a sensing measurement quantity identity;
a device identity participating in sensing measurement;
a cell identity;
a time domain resource information;
a frequency domain resource information; and
a codeword number.

That is, the first device may generate the scrambling sequence based on one or more of the above parameters to scramble the first signal, such that interference between signals for communication and sensing, different sensing services, different sensing zones and different sensing targets is randomized, and may be applied to various sensing application scenes. Thus, sensing performance is improved.

In the embodiment, the first information is received by the first device from the second device or another device, or may be determined by the first device.

Optionally, the sensing zone identity is used for indicating at least one of the following:
a sensing zone composed of a plurality of base station coverage zones;
a sensing zone under a single base station coverage zone;
a sensing zone corresponding to a particular angle range of a single base station; and
a geographic zone identity.

It should be noted that in the embodiment, the sensing zone is a to-be-sensed target zone and may be divided in advance. The sensing zone identity is an identifier (ID) associated with each sensing zone after division. The sensing zone identity may be recorded as n_{areaID}.

In an implementation, the sensing zone includes the plurality of base station coverage zones (cells) that constitute one sensing zone, and is associated with one sensing zone identity. For example, as shown in FIG. 3, each hexagonal zone represents the base station coverage zone, and zones filled with a same background represent a same sensing zone. Particularly, a notification area of a radio access network (RAN) (RAN-based notification area, RNA) may be regarded as one sensing zone, and an RNA ID may be regarded as the sensing zone identity.

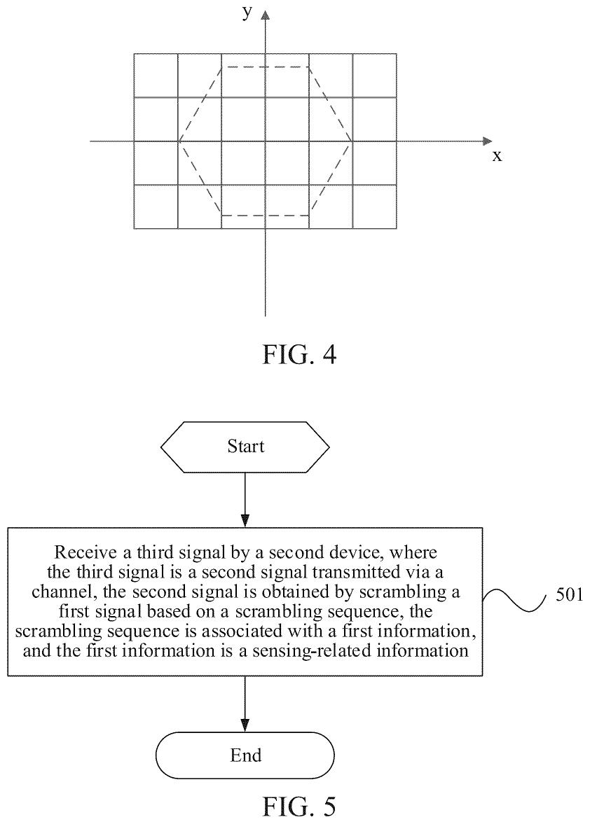

In an implementation, the sensing zones are a plurality of sensing zones included in the single base station coverage zone (cell), and are associated with a plurality of sensing zone identities. For example, coverage of a base station is divided into a plurality of sensing zones through rasterization with the base station as an origin. Each sensing zone is associated with a zone ID (n_{areaID}). As shown in FIG. 4, a dotted line represents the base station coverage zone, and each block represents a divided sensing zone.

In an implementation, the sensing zone is a zone corresponding to the geographic zone identity (for example, a longitude and latitude or a coordinate position), and is associated with the sensing zone identity.

In an implementation, the sensing zones are zones corresponding to different angle ranges of the base station, and are associated with different sensing zone identities. For example, azimuth angles x1° to x2° and pitch angles y1° to y2° correspond to a sensing zone ID1.

Optionally, in the embodiment, the identity (recorded as n_{sensing1ID}) indicating whether the second signal is used for sensing may use different values to indicate whether the second signal is used for sensing. For example, n_{sensing1ID}=0 or 1. In a case that the second signal is not used for sensing, n_{sensing1ID}=0. In a case that the second signal is used for sensing, n_{sensing1ID}=1.

Optionally, in the embodiment, the sensing service identity (recorded as n_{sensing2ID}) is an identity pre-allocated to different sensing services. Different sensing services correspond to different sensing service identities. For example, if a sensing service initiated by a sensing demand side is a sensing service 2, and corresponds to n_{sensing2ID2}, a transmission device generates the scrambling sequence based on n_{sensing2ID2}, scrambles the first signal, and transmits the first signal to the reception end, that is, the second device.

The sensing service may be at least one of the following:
detection of existence of targets, positioning, speed detection, distance detection, angle detection, acceleration detection, material analysis, composition analysis, shape detection, category classification, radar cross section (RCS) detection, polarization scattering characteristic detection, fall detection, intrusion detection, quantitative statistics, indoor positioning, gesture identification, lip language identification, gait identification, expression identification, facial identification, respiratory monitoring, heart rate monitoring, pulse monitoring, humidity/brightness/temperature/atmospheric pressure monitoring, air quality monitoring, weather monitoring, environmental reconstruction, topography, building/vegetation distribution detection, human flow or vehicle flow detection, crowd density detection, vehicle density detection, etc.

Optionally, in the embodiment, the sensing service type identity (recorded as n_{sensing3ID}) is an identity of a sensing service type. Different types of sensing services correspond to different sensing service identities. For example, the sensing services are classified into the following three types according to a range scale:

1. First type (short distance/small range): material analysis, composition analysis, gesture identification, lip language identification, gait identification, expression identification, facial identification, respiratory monitoring, heart rate monitoring, pulse monitoring, etc.

2. Second type (medium distance/medium range): intrusion detection, quantity statistics, indoor positioning, etc.

3. Third type (long distance/large range): humidity/brightness/temperature/atmospheric pressure monitoring, air quality monitoring, weather monitoring, environment reconstruction, topography, building/vegetation distribution detection, human flow or vehicle flow detection, etc.

Clearly, classification standards of the sensing services may further be classified into positioning sensing, imaging sensing, identification sensing, etc. according to functions. Or, classification standards of the sensing services may be divided according to power consumption/energy consumption, resource occupation, etc.

In addition, in the embodiment, the identity indicating whether to be used for sensing, the sensing service identity or the sensing service type identity may be recorded as n_{sensingID}.

Optionally, in the embodiment, the sensing target identity is an identity of a sensing target, and is recorded as n_{targetID}. Different sensing targets correspond to different sensing target IDs. The first device may obtain the sensing target identity, which may be prior information obtained based on an existing measurement result. For example, the first device (a base station A) transmits a sensing measurement signal through an omni-directional beam for preliminary measurement, and the base station A obtains a distance-Doppler diagram (or a distance-angle diagram), determines a number of targets (sensing targets) according to the distance-Doppler diagram, and assigns an ID to each target. Or, the first device (a base station A) transmits a sensing measurement signal through an omni-directional beam for preliminary measurement, and the reception end (for example, another base station or terminal) obtains a distance-Doppler diagram (or a distance-angle diagram), determines a number of targets (sensing targets) according to the distance-Doppler diagram, and assigns an ID to each target. Further, target IDs and/or target-related information are notified to a transmission base station.

After the first device generates the scrambling sequence based on the sensing target identity, the generated scrambling sequence is further used for scrambling a signal corresponding to the sensing targets. In addition, the second signal, corresponding to different sensing targets, obtained through scrambling is transmitted through different beams, and a beam direction points to the sensing targets associated with the sensing target identities.

Clearly, the sensing target identities may be identities of sensing target types, and different types of sensing targets correspond to different sensing target IDs. For example, the sensing targets may be divided into static targets and moving targets based on motion states. The moving targets may be further divided into high-speed targets and low-speed targets based on speeds. Different types of targets correspond to different n_{targetID}.

Optionally, in the embodiment, a tag identity associated with the sensing target may be a Tag ID associated with a Tag configured on the sensing target. Different Tags are associated with different Tag IDs. The Tag may denote a device supporting backscatter communication. An excitation source may be a device other than the Tag, or an excitation source is the Tag itself. Or, the Tag may be UE. That is, the sensing target is provided with a common transceiving module. For example, a vehicle is provided with a communication device (for example, an in-vehicle terminal).

Optionally, in the embodiment, the sensing measurement quantity identities are identities corresponding to one or more sensing measurement quantities. For example, a mapping table between sensing measurement quantity IDs and sensing measurement quantities is preset as shown in Table 2.

TABLE 2

| Sensing measurement | |
|---|---|
| quantity ID | Sensing measurement quantity |
| ID1 | Time delay/distance |
| ID2 | Doppler/speed |
| ID3 | Angle |
| ID4 | Time delay/distance, and Doppler/speed |
| ID4 | Time delay/distance, Doppler/speed, and angle |
| . . . | . . . |

Optionally, in the embodiment, a device identity participating in sensing measurement is an identity of a device participating in sensing measurement, and for example, an identity of the first device, an identity of the second device (a reception end device), or an identity of a sensing server. The first device and/or the second device are/is UE, and identities of the first device and/or the second device may be radio network temporary identities (RNTI).

Optionally, in the embodiment, a cell identity may be an identity of a cell corresponding to a base station in a case that the first device and/or the second device are/is base stations. Or, a cell identity may be an identity of a cell in which the sensing target is located.

Optionally, in the embodiment, the time domain resource information includes at least one of the following:
a radio frame number, a sub-frame number, a slot number, a symbol number, duration, a time domain density, a cyclic prefix (CP) type, and a CP length.

The frequency domain resource information includes at least one of the following:
a resource element (RE) index, a resource block (RB) index, frequency point information, frequency band information, a bandwidth, a frequency domain density, and a subcarrier spacing.

Herein, the time domain and/or frequency domain resource information may be a transmission time domain and/or frequency domain resource information of the second signal.

Optionally, in the embodiment, an initial value of the scrambling sequence is associated with the first information.

That is, the step that the first device obtains the scrambling sequence according to the first information includes the following step: the initial value of the scrambling sequence is determined according to the first information, and the scrambling sequence is obtained according to the initial value of the scrambling sequence.

In an implementation, the initial value (cᵢₙᵢₜ) of the scrambling sequence may be obtained through the first information (for example, the sensing zone identity). For example,

1) cᵢₙᵢₜ=n_{areaID}, where n_{areaID} denotes the sensing zone identity.

2)

$${c}_{init} = {2}^{x} ( {N}_{symb}^{slot} {n}_{s , f}^{μ} + l + 1 ) + {n}_{areaID} ,$$

$$where {N}_{symb}^{slot}$$

denotes a number of symbols in each slot, n_{s,f}^{μ} denotes a number of slots in each frame during subcarrier spacing configuration, l denotes a symbol number in the slot, and x denotes a non-negative positive integer. A coefficient parameter 2^{x} may be determined according to a range of other variables in the formula and values of other coefficient parameters. For example, there are 1000 sensing zone IDs, which need to be represented by a 10-bit binary number, such that x=10, and it may be ensured that there is no repeated scrambling initial value.

$${c}_{init} = {2}^{x} ( {N}_{symb}^{slot} {n}_{s , f}^{μ} + l + 1 ) ( 2 {N}_{ID}^{cell} + 1 ) + {2}^{y} {N}_{ID}^{cell} + {n}_{areaID} , \qquad 3 )$$

$$where {N}_{ID}^{cell}$$

denotes a physical cell identity, and x and y denote non-negative positive integers. Or,

$${c}_{init} = {2}^{x} ( {N}_{symb}^{slot} {n}_{s , f}^{μ} + l + 1 ) ( 2 {n}_{areaID} + 1 ) + {2}^{y} 2 {n}_{areaID} + {N}_{ID}^{cell} .$$

$${c}_{init} = {2}^{x} {n}_{RNTI} + {n}_{areaID} , \qquad 4 )$$

$$or$$

$${c}_{init} = ( {2}^{x} {n}_{RNTI} + {n}_{areaID} ) mod {2}^{A} ,$$

where n_{RNTI} denotes a terminal identity of a device participating in sensing measurement, x and A denote non-negative positive integers, and A is preset. For example, A may be equal to 31.

$${c}_{init} = {2}^{x} {n}_{RNTI} + {2}^{y} {N}_{ID}^{cell} + {n}_{areaID} , \qquad 5 )$$

$$or$$

$${c}_{init} = ( {2}^{x} {n}_{RNTI} + {2}^{y} {N}_{ID}^{cell} + {n}_{areaID} ) mod {2}^{A} .$$

$$Or ,$$

$${c}_{init} = {2}^{x} {n}_{RNTI} + {2}^{y} {N}_{ID}^{cell} + {n}_{areaID} ,$$

$$or$$

$${c}_{init} = ( {2}^{x} {n}_{RNTI} + {2}^{y} {n}_{areaID} + {N}_{ID}^{cell} ) mod {2}^{A} ,$$

where x, y and A denote non-negative positive integers, and A=31.

$${c}_{init} = {2}^{x} {n}_{RNTI} + {2}^{y} q + {2}^{z} {N}_{ID}^{cell} + {n}_{areaID} , \qquad 6 )$$

$$or$$

$${c}_{init} = ( {2}^{x} {n}_{RNTI} + {2}^{y} q + {2}^{z} {N}_{ID}^{cell} + {n}_{areaID} ) mod {2}^{A} ,$$

where q denotes a codeword number. Or,

$${c}_{init} = {2}^{x} {n}_{RNTI} + {2}^{y} q + {2}^{z} {n}_{areaID} + {N}_{ID}^{cell} ,$$

$$or$$

$${c}_{init} = ( {2}^{x} {n}_{RNTI} + {2}^{y} q + {2}^{z} {n}_{areaID} + {N}_{ID}^{cell} ) mod {2}^{A} ,$$

where x, y, z and A denote non-negative positive integers, and A=31.

7) cᵢₙᵢₜ=n_{RNTI}·2^{B}+n_{ID}+n_{sensingID}, where n_{sensingID} denotes the identity indicating whether to be used for sensing, n_{sensing1ID}=0 or 1, and n_{sensingID}=0 in a case that the second signal is not used for sensing (an initial scrambling value is consistent with that of an original communication service). In a case that the second signal is used for sensing, n_{sensingID}=1, and B=16, for example, a physical uplink shared channel (PUSCH) scrambling sequence.

In addition, if the first information is the sensing service identity n_{sensingID}, according to 1) to 6), the initial value of the scrambling sequence may be obtained by replacing n_{areaID} with n_{sensingID}. If the first information is the sensing target identity n_{targetID}, according to 1) to 6), the initial value of the scrambling sequence may be obtained by replacing n_{areaID} with n_{targetID}. Similarly, other first information may be applied to 1) to 6).

In addition, the initial value of the scrambling sequence may be determined through two or more pieces of the first information, and for example,

$${c}_{init} = {2}^{x} ( {N}_{symb}^{slot} {n}_{s , f}^{μ} + l + 1 ) + {2}^{x} {n}_{areaID} + {n}_{targeID} .$$

Clearly, methods for generating the initial value of the scrambling sequence according to one or more pieces of the first information are not limited to the above description, and are not listed one by one herein.

It should be noted that, in the embodiment, in a case that the initial value of the scrambling sequence is determined based on the sensing target identity, after the first device determines an identity of each sensing target, the initial value of the scrambling sequence is determined through different sensing target identities. When the initial value of the scrambling sequence is determined based on a tag identity associated with the sensing target, the first device determines the Tag identity of the sensing target and obtains the initial value of the corresponding scrambling sequence.

It should be noted that in the embodiment, a method for generating the scrambling sequence is as follows: c(n)=(x₁(n+N_{C})+x₂(n+N_{C}))mod 2, x₁(n+31)=(x₁(n+3)+x₁(n))mod 2, and x₂(n+31)=(x₂(n+3)+x₂(n+2)+x₂(n+1)+x₂(n))mod 2, where n=0, 1, . . . , M_{PN}−1, and M_{PN} denotes a sequence length. N_{C}=1600, and an initialization mode of a first m sequence x₁(n) is x₁(0)=1, x₁(n)=0, n=1, 2, . . . , 30. An initialization mode of a second m sequence x₂(n) is

$${c}_{init} = {\sum }_{i = 0}^{30} {x}_{2} ( i ) \cdot {2}^{i} .$$

It should be further noted that when multi-device joint sensing on a same sensing zone is performed, a plurality of devices generate a scrambling sequence through a common sensing zone ID. Optionally, an initial value of the scrambling sequence is not related to a cell identity or a UE identity. That is, different transmission devices may use a same scrambling sequence to scramble and transmit the first signal, and a reception end may use a same scrambling sequence to descramble a signal from different transmission devices and further perform sensing computation. Thus, signaling notification overhead is reduced, and measurement efficiency is improved.

Optionally, in the embodiment, the step that the first device scrambles the first signal according to the scrambling sequence includes at least one of the following scrambling:
bit-level scrambling; and
symbol-level scrambling.

The bit-level scrambling is to scramble a bit sequence corresponding to the first signal, and for example, to compute scrambling a signal through \tilde{b}(i)=(b(i)+c(i))_{mod}2. b(i) denotes a bit sequence before modulation corresponding to the first signal, and c(i) denotes the scrambling sequence. The symbol-level scrambling is to scramble modulation symbols corresponding to the first signal. For example, the symbol-level scrambling may be as follows: The scrambling sequence is modulated in a same modulation mode. I-channel data (a solid box) of the modulation symbols corresponding to the first signal is denoted by Xr. Q-channel data (a dotted box) is denoted by Xi. I-channel data (a solid box) of the modulation symbols corresponding to the scrambling sequence is denoted by Cr. Q-channel data (a dotted box) is denoted by Ci. In this way, a solid box of a scrambled signal is: Yr(i)=Xr(i)·sgn(Cr(i)). A dotted box of a scrambled signal is: Yi(i)=Xi(i)·sgn(Ci(i)), where

$$sgn ( x ) = \{ \begin{matrix}1 , & x is greater than or equal to 0 \\ - 1 , & x is less than 0\end{matrix} .$$

Optionally, in the embodiment, the first signal includes at least one of the following:
a communication data bearing signal;
a reference signal;
a synchronization signal; and
a sensing-dedicated signal.

For example, the communication data bearing signal is a signal of a physical downlink shared channel (PDSCH) and a physical uplink shared channel (PUSCH), or a signal of a physical downlink control channel (PDCCH) and a physical uplink control channel (PUCCH).

For example, the reference signal is a demodulation reference signal (DMRS), a channel state information-reference signal (CSI-RS), a channel sounding reference signal (SRS), a downlink positioning reference signal (PRS), etc.

For example, the synchronization signal is a primary synchronization signal (PSS) or a secondary synchronization signal (SSS).

The sensing-dedicated signal is a signal dedicated to sensing measurement, such as a sensing signal generated based on Chirp or a frequency modulated continuous wave (FMCW) signal, or a sensing signal generated based on a pseudo-noise (PN) sequence, a pseudo-random sequence, etc.

In an implementation, the first signal may be part of a signal. For example, several symbols in a PDSCH are used as the first signal. Or, the first signal may be different types of signals. For example, symbols bearing PDSCH data and a PDSCH DMRS are jointly used as the first signal.

In the embodiment, the second device is a reception end of the second signal, and the second device receives the third signal (the second signal transmitted via a channel).

Optionally, after the second device receives the third signal, the scrambling sequence is obtained according to the first information. The first signal is scrambled according to the scrambling sequence, and the second signal is obtained. A sensing measurement result is obtained according to the second signal and the third signal.

That is, the second device may obtain the scrambling sequence together with the first device according to the first information, and scramble the first signal according to the scrambling sequence, so as to obtain the second signal. Specific implementation will not be described in detail herein. In this way, the second device may obtain the sensing measurement result according to the generated second signal and the received third signal. For example, channel information is obtained based on the second signal and the third signal, and then the sensing measurement result is obtained according to the channel information. The second device may transmit the obtained sensing measurement result.

Optionally, if the first signal is the communication data bearing signal, the first signal is unknown to the second device, and the second device may descramble and decode the third signal according to the scrambling sequence, and obtain the first signal. Then, the first signal is scrambled according to the scrambling sequence obtained from the first information, and the second signal is obtained. If the first signal is the signal bearing no communication data, such as the reference signal, the synchronization signal, and the sensing-dedicated signal, the first signal is known to the second device, and the second device may scramble the first signal directly according to the scrambling sequence obtained from the first information and obtain the second signal.

Optionally, in the embodiment, the method further includes the following step:
the first device transmits the first information.

That is, the second device may receive the first information transmitted by the first device. Thus, the second device may directly obtain the scrambling sequence, for example, the initial value of the scrambling sequence, based on the received first information. Clearly, the first information received by the second device may be transmitted by other devices.

In an implementation, the first device transmits first signaling. The first signaling is used for notifying the second device of the first information.

Optionally, in the embodiment, the method further includes the following step:
the first device transmits a candidate set of the first information.

That is, the second device may receive the candidate set of the first information transmitted by the first device, and then determine the first information based on the candidate set. Thus, the second device may detect the third signal according to the candidate set of the received first information so as to determine the first information.

Specifically, the second device generates a plurality of scrambling sequences according to the candidate set of the first information. When the first signal is the communication data bearing signal, the second device descrambles and decodes the third signal according to the plurality of scrambling sequences. If decoding is correct (cyclic redundancy check (CRC) is passed), information corresponding to a current scrambling sequence is the first information associated with the third signal. When the first signal is the reference signal, the synchronization signal, or the sensing-dedicated signal, the second device determines a plurality of second signals based on the first signal and the plurality of scrambling sequences, and then performs correlation detection on the third signal and the third signal for example. The first information associated with the third signal is determined according to comparison between a correlation peak and a preset threshold.

Clearly, the candidate set of the first information received by the second device may be transmitted by other devices. Or, the candidate set of the first information is predefined or configured.

In an implementation, the first device transmits second signaling. The second signaling is used for notifying the candidate set of the first information. If the first information is the sensing zone identity, a first information set is a set of a plurality of different sensing zone identities, and the plurality of scrambling sequences are determined based on the different sensing zone identities.

Optionally, in a case that the third signal is detected according to the candidate set to obtain a detection result and the detection result does not satisfy a preset threshold or indicates a decoding error, the second device transmits a detection failure instruction to the first device.

The detection failure instruction is used for instructing the first device to execute at least one of the following:
the second signal is retransmitted; and
the first information is transmitted.

In this way, the first device may retransmit the second signal after receiving the detection failure instruction; and/or, the first information is transmitted.

The detection result may be a correlation peak. The detection result does not satisfy the preset threshold, which means that all correlation peaks obtained through correlation detection do not satisfy a corresponding preset threshold requirement.

Optionally, in the embodiment, the first device transmits first configuration information. The first configuration information is used for receiving the third signal. The first configuration information includes at least one of the following:
a signal resource identity;
a waveform;
a subcarrier spacing;
a guard interval;
a time domain and/or frequency domain resource information;
a signal power;
a sequence information;
a signal direction; and
a quasi co-location relationship.

In this way, the second device receives the first configuration information transmitted by the first device, and receives the third signal according to the first configuration information. Clearly, the second device may receive the first configuration information transmitted by other devices.

The signal resource identity is used for distinguishing different signal resource configurations. The waveform may be orthogonal frequency division multiplex (OFDM), single-carrier frequency-division multiple access (SC-FDMA), orthogonal time frequency space (OTFS), a frequency modulated continuous wave (FMCW), a pulse signal, etc. The subcarrier spacing may be a subcarrier spacing 30 KHz of an OFDM system;

The guard interval is a time interval from a moment when transmission of a signal is ended to a moment when a latest echo signal of the signal is received. This parameter is directly proportional to a maximum sensing distance. For example, the parameter may be computed through c/(2Rₘₐₓ), and Rₘₐₓ denotes a maximum sensing distance (belonging to sensing demand information). For example, for a sensing signal received spontaneously, Rₘₐₓ denotes a maximum distance from a transceiving point of the sensing signal to a signal transmission point. In some cases, an OFDM signal cyclic prefix (CP) may play a role of a minimum guard interval, and c denotes a light speed. The frequency domain resource information includes: a frequency domain start position, that is, a start frequency point, or a start RE or an RB index; a frequency domain resource length, that is, a frequency domain bandwidth, where the frequency domain bandwidth is inversely proportional to distance resolution, a frequency domain bandwidth of each first signal satisfies B≥c/(2ΔR), c denotes a light speed, and ΔR denotes the distance resolution; and a frequency domain resource interval, where the frequency domain resource interval is inversely proportional to a maximum unambiguous distance/time delay, and when subcarriers are mapped continuously, a frequency domain interval of an OFDM system is equal to the subcarrier spacing. The time domain resource information includes: a time domain start position, that is, a start time point, or a start symbol, a slot or a frame index; a time domain resource length referred to as burst duration, where the time domain resource length is inversely proportional to Doppler resolution; and a time domain resource interval, where the time domain resource interval is a time interval between two adjacent signals, and the time domain resource interval is associated with a maximum unambiguous Doppler shift or a maximum unambiguous speed. The signal power uses a value at intervals of 2 dBm from −20 dBm to 23 dBm for example. The sequence information includes the used generation sequence (such as a ZC sequence or a PN sequence) and a generation method. The signal direction includes angle information or beam information of signal transmission. The quasi co-location (QCL) relationship may be QCL between each of a plurality of resources (third signal resources) and one synchronization signal block (SSB). The QCL includes Type A, B, C or D.

In an implementation, the first configuration information is indicated through third signaling.

Optionally, in the embodiment, the first device transmits a second configuration information. The second configuration information is used for performing sensing measurement and/or reporting a sensing measurement result. The second configuration information includes at least one of the following:
a sensing measurement quantity;
a time domain and/or frequency domain resource for reporting;
a reporting mode; and
a triggering condition for reporting.

In this way, the second device receives the second configuration information transmitted by the first device, and performs sensing measurement according to the second configuration information, and/or, reports the sensing measurement result. Clearly, the second device may receive the first configuration information transmitted by other devices.

The reporting mode includes: periodic reporting, which is reporting according to a specified time offset and/or period; semi-persistent reporting, where reporting is performed according to a specified period after a report start indication is received, reporting is stopped after a report stop indication is received, the report start indication is used for indicating start of a corresponding sensing report, and the report stop indication is used for indicating stop of reporting; and aperiodic reporting, which is reporting at a specified moment or in a case that a preset condition is satisfied.

The triggering condition of reporting may be that the sensing measurement result or sensing performance corresponding to the sensing measurement result satisfies the preset condition, and for example, the sensing measurement result satisfies a preset interval range, or a power value of a signal component associated with the sensing target satisfies the preset threshold.

In an implementation, the second configuration information is indicated through fourth signaling.

In the embodiment, the first signaling, the second signaling, the third signaling, and the fourth signaling may be combined into one or more pieces of signaling.

In the embodiment, the sensing measurement result refers to a measurement result corresponding to the sensing measurement quantity, that is, a value of the sensing measurement quantity. The sensing measurement quantities may be classified into the following types:
a) first-grade measurement quantities (a reception signal/an original channel information) include: a reception signal/channel response complex result, an amplitude/phase, I-path/Q-path and their operation results (operations includes addition, subtraction, multiplication and division, addition, subtraction and multiplication of matrices, matrix transposition, triangular relation operation, square root operation, power operation, etc., and threshold detection results, maximum/minimum value extraction results, etc. of the operation results; and the operations further include fast Fourier transform (FFT)/inverse fast Fourier transform (IFFT), discrete Fourier transform (DFT)/inverse discrete Fourier transform (IDFT), 2-dimensional FFT (2D-FFT), 3-dimensional FFT (3D-FFT), matched filtering, an autocorrelation operation, wavelet transform, digital filtering, etc., and threshold detection results, maximum/minimum value extraction results, etc. of the operation results);
b) second-grade measurement quantities (basic measurement quantities) include: a time delay, Doppler, an angle, an intensity, and their multidimensional combination representation;
c) third-grade measurement quantities (basic attributes/states) include: a distance, a speed, an orientation, a spatial position, and an acceleration; and
d) fourth-grade measurement quantities (advanced attributes/states) include: whether a target exists, a trajectory, an action, an expression, a vital sign, a quantity, an imaging result, weather, air quality, a shape, a material, and a component.

Optionally, in the embodiment, the first device includes a base station or a terminal. The second device includes a base station or a terminal.

In the embodiment, a transmission device for signaling and/or a reception device for a sensing measurement result may be used in the following conditions:

1. The first device transmits the signaling to the second device and/or receives the sensing measurement result. In this case, the first device (a signal transmission device) and the second device (a signal reception device) are different devices. For example,
the first device is a base station, and the second device is a terminal;
the first device is a base station A, and the second device is a base station B; or,
the first device is a terminal A, and the second device is a terminal B.

2. A third device transmits the signaling to the second device and/or receives the sensing measurement result. In this case, the first device and the second device are different devices. For example,
the first device is a base station, the second device is a terminal, and the third device is a sensing network function;
the first device is a base station A, the second device is a base station B, and the third device is a sensing network function;
the first device is a terminal A, the second device is a terminal B, and the third device is a sensing network function or a base station; or,
the first device is a terminal, the second device is a base station, and the third device is a sensing network function.

3. A third device transmits the signaling to the second device and/or receives the sensing measurement result. In this case, the first device and the second device are a same device. For example,
the first device and the second device are a base station A, and the third device is a sensing network function; and
the first device and the second device are a terminal A, and the third device is a sensing network function or a base station.

Signaling transmission between the base station and the terminal, and between the terminal A and the terminal B may use radio resource control (RRC) signaling, a media access control (MAC) control element (CE) or layer 1 signaling, or other newly-defined sensing signaling. Signaling transmission between the sensing network function and the terminal may use non-access stratum (NAS) signaling (forwarded by an authentication management function (AMF)), and/or RRC signaling, MAC CE or layer 1 signaling, or other newly defined sensing signaling. Interaction between the sensing network function and the base station may be forwarded to a radio access network by the AMF through an N2 interface. Or, interaction may be transmitted to a user plane function (UPF) through a core network sensing network function, and the UPF transmits the function to the radio access network through an N3 interface. Or, interaction may be transmitted as a radio access network (base station) through a newly defined interface. Signaling transmission between base stations may be performed through an Xn interface.

The sensing network function is described as follows:

The sensing network function may be referred to as a sensing network element or a sensing management function (Sensing MF), and may be located at an RAN side or a core network side, and refer to a network node in the core network and/or RAN, which is responsible for at least one function such as sensing request processing, sensing resource scheduling, sensing information interaction, sensing data processing, etc. Or, the sensing network function may be based on upgrade of the AMF or a location management function (LMF) in a 5G network, or may be another network node or a newly defined network node. Specifically, functional characteristics of the sensing network function/the sensing network element may include at least one of the following:

1) Target information interaction is performed with a radio signal transmission device and/or a radio signal measurement device (including a target terminal, a serving base station of a target terminal, or a base station associated with a target zone). Target information includes a sensing processing request, a sensing capability, auxiliary sensing data, a sensing measurement quantity type, sensing resource configuration information, etc. In this way, a value of a target sensing result or a sensing measurement quantity (uplink measurement or downlink measurement) is transmitted by the radio signal measurement device. A radio signal may alternatively be referred to as a sensing signal.

2) According to a type of a sensing service, sensing service consumer information, required information of sensing quality of service (QoS), a sensing capability of the radio signal transmission device, a sensing capability of the radio signal measurement device and other factors, the used sensing method is determined. The sensing method may include: transmission by a base station A and reception by a base station B, transmission by a base station and reception by a terminal, self-transmission and self-reception by a base station A, transmission by a terminal and reception by a base station, self-transmission and self-reception by a terminal, or transmission by a terminal A and reception by a terminal B.

3) According to the type of the sensing service, the sensing service consumer information, the required information of sensing QoS, the sensing capability of the radio signal transmission device, the sensing capability of the radio signal measurement device and other factors, a sensing device serving a sensing service is determined. The sensing device includes the radio signal transmission device and/or the radio signal measurement device.

4) Overall coordination and scheduling of resources required for the sensing service are managed. For example, sensing resources of the base station and/or the terminal are configured accordingly.

5) Data processing is performed on the value of the sensing measurement quantity, or computation is performed to obtain a sensing result. Further, the sensing result is verified, and sensing accuracy is estimated.

To sum up, according to the method in the embodiment of the present disclosure, different initial values of scrambling sequences are obtained based on the first information, and interference randomization of a scrambled signal is performed according to scrambling sequences generated by different initial values of scrambling. In this way, interference between signals for communication and sensing, different sensing services, different sensing zones and different sensing targets is randomized, and may be applied to various sensing application scenes. Thus, sensing performance is improved. On one hand, the scrambled second signal may be used for bearing the first information, and the reception end may obtain the first information by detecting the third signal, such that signaling overhead caused by an display indication can be reduced. On the other hand, an encryption function is included, that is, a device that does not know the scrambling sequence cannot accurately perform sensing. Thus, sensing security is improved.

As shown in FIG. 5, a method for transmission processing according to an embodiment of the present disclosure includes the following step:

Step 501, a second device receives a third signal.

The third signal is a second signal transmitted via a channel. The second signal is obtained by scrambling a first signal based on a scrambling sequence. The scrambling sequence is associated with first information. The first information is sensing-related information.

In this case, the third signal received by the second device is a second signal transmitted via a channel. The second signal is obtained by scrambling the first signal based on the scrambling sequence. The scrambling sequence is associated with the first information. The first information is the sensing-related information. Thus, not only sensing-oriented interference is randomly distributed, but also the sensing-related information is carried by the second signal. In this way, a reception end may obtain the sensing-related information through detection, and signaling overhead may be reduced.

Optionally, the first information includes at least one of the following:
a sensing zone identity;
an identity indicating whether to be used for sensing;
a sensing service identity;
a sensing service type identity;
a sensing target identity;
a tag identity associated with a sensing target;
a sensing measurement quantity identity;
a device identity participating in sensing measurement;
a cell identity;
a time domain resource information;
a frequency domain resource information; and
a codeword number.

Optionally, the sensing zone identity is used for indicating at least one of the following:
a sensing zone composed of a plurality of base station coverage zones;
a sensing zone under a single base station coverage zone;
a sensing zone corresponding to a particular angle range of a single base station; and
a geographic zone identity.

Optionally, the time domain resource information includes at least one of the following:
a radio frame number, a sub-frame number, a slot number, a symbol number, duration, a time domain density, a CP type, and a CP length.

The frequency domain resource information includes at least one of the following:
an RE index, an RB index, frequency point information, frequency band information, a bandwidth, a frequency domain density, and a subcarrier spacing.

Optionally, an initial value of the scrambling sequence is associated with the first information.

Optionally, after the second device receives the third signal, the method further includes the following steps:
the second device obtains the scrambling sequence according to the first information;
the second device scrambles the first signal according to the scrambling sequence, and the second signal is obtained; and
the second device obtains a sensing measurement result according to the second signal and the third signal.

The second device may obtain the scrambling sequence together with the first device according to the first information, scrambles the first signal according to the scrambling sequence, and obtains the second signal. Specific implementation will not be described in detail herein. In this way, the second device may obtain the sensing measurement result according to the generated second signal and the received third signal. For example, channel information is obtained based on the second signal and the third signal, and then the sensing measurement result is obtained according to the channel information.

Optionally, if the first signal is the communication data bearing signal, the first signal is unknown to the second device, and the second device may descramble and decode the third signal according to the scrambling sequence, and obtain the first signal. Then, the first signal is scrambled according to the scrambling sequence obtained from the first information. If the first signal is the signal bearing no communication data, such as the reference signal, the synchronization signal, and the sensing-dedicated signal, the first signal is known to the second device, and the second device may scramble the first signal directly according to the scrambling sequence obtained from the first information.

Optionally, before the second device scrambles the first signal according to the scrambling sequence, the method further includes the following steps:
in a case that the first signal is a communication data bearing signal, the second device descrambles and decodes the third signal according to the scrambling sequence, and the first signal is obtained.

Optionally, before the second device obtains the scrambling sequence according to the first information, the method further includes the following step:
the second device receives the first information; or,
the second device obtains a candidate set of the first information, and the third signal is detected according to the candidate set, so as to determine the first information.

Thus, the second device may directly obtain the scrambling sequence, for example, the initial value of the scrambling sequence, based on the received first information. Further, the second device may detect the third signal according to the candidate set of the received first information so as to determine the first information.

Specifically, the second device generates a plurality of scrambling sequences according to the candidate set of the first information. When the first signal is the communication data bearing signal, the second device descrambles and decodes the third signal according to the plurality of scrambling sequences. If decoding is correct (CRC is passed), information corresponding to a current scrambling sequence is the first information associated with the third signal. When the first signal is the reference signal, the synchronization signal, or the sensing-dedicated signal, the second device determines a plurality of second signals based on the first signal and the plurality of scrambling sequences, and then performs correlation detection on the third signal and the third signal for example. The first information associated with the third signal is determined according to comparison between a correlation peak and a preset threshold.

With a case that the first information is the sensing service ID as an example, assuming that a quantity of candidate sensing services is n and the candidate sensing services correspond to n sensing service identities (a first information set): {n_{sensingID1}, n_{sensingID2}, . . . , n_{sensingIDn}}. The first information set may be predefined. That is, the first device and the second device (transmission and reception ends) know all the candidate sensing services and corresponding identities, which may be transmitted to the second device (a reception device) by the first device (a transmission device) or other devices. If a sensing service initiated by a sensing demand side is a sensing service 2, and corresponds to n_{sensingID2}, the first device generates the scrambling sequence based on n_{sensingID2}, scrambles the first signal, and transmits the first signal to the second device.

The second device generates n scrambling sequences based on n_{sensingID1}, n_{sensingID2}, . . . , and n_{sensingIDn} respectively.

If the first signal is the communication data bearing signal, the second device descrambles and decodes the third signal (a reception signal) based on the n scrambling sequences respectively. It may be considered that only when the scrambling sequence is generated based on n_{sensingID2}, the third signal may be descrambled and decoded correctly, that is, CRC is passed, and then the second device may determine a specific sensing service identity n_{sensingID2}.

If the first signal is the reference signal, the synchronization signal or the sensing-dedicated signal, that is, the first signal is known to the second device, the second device uses the n scrambling sequences to scramble the first signal respectively so as to obtain n local signals, and performs correlation detection on the local signals and the reception signal respectively. It may be considered that only when the scrambling sequence is generated based on n_{sensingID2} and the first signal is scrambled, the obtained second signal (local signal) is highly correlated with the third signal, the correlation peak exceeding the preset threshold may be obtained, and then the second device may determine the specific sensing service identity n_{sensingID2}.

The first information is transmitted by the first device, or is transmitted by another device. The candidate set of the first information may be predefined or configured, or transmitted by the first device and other devices.

Optionally, the method further includes the following step:
in a case that the third signal is detected according to the candidate set to obtain a detection result and the detection result does not satisfy a preset threshold or indicates a decoding error, the second device transmits a detection failure instruction to the first device.

The detection failure instruction is used for instructing the first device to execute at least one of the following:
the second signal is retransmitted; and
the first information is transmitted.

Optionally, before the second device receives the third signal, the method further includes the following step:
the second device receives first configuration information. The first configuration information is used for receiving the third signal. The first configuration information includes at least one of the following:
a signal resource identity;
a waveform;
a subcarrier spacing;
a guard interval;
a time domain and/or frequency domain resource information;
a signal power;
a sequence information;
a signal direction; and
a quasi co-location relationship.

Optionally, the method further includes the following step:
the second device receives a second configuration information. The second configuration information is used for performing sensing measurement and/or reporting a sensing measurement result. The second configuration information includes at least one of the following:
a sensing measurement quantity;
a time domain and/or frequency domain resource for reporting;
a reporting mode; and
a triggering condition for reporting.

Optionally, the first signal includes at least one of the following:
a communication data bearing signal;
a reference signal;
a synchronization signal; and
a sensing-dedicated signal.

Optionally, in the embodiment, the first device includes a base station or a terminal. The second device includes a base station or a terminal.

It should be noted that the method is implemented in cooperation with the method executed by the first device, and an implementation of the embodiment of the method for scrambling processing of the first device is applicable to the method and can achieve same technical effects, which will not be repeated herein.

An execution body of the method for scrambling processing according to the embodiment of the present disclosure may be an apparatus for scrambling processing. In the embodiment of the present disclosure, the apparatus for scrambling processing according to the embodiment of the present disclosure is illustrated with a case of using the apparatus for scrambling processing to execute the method for scrambling processing as an example.

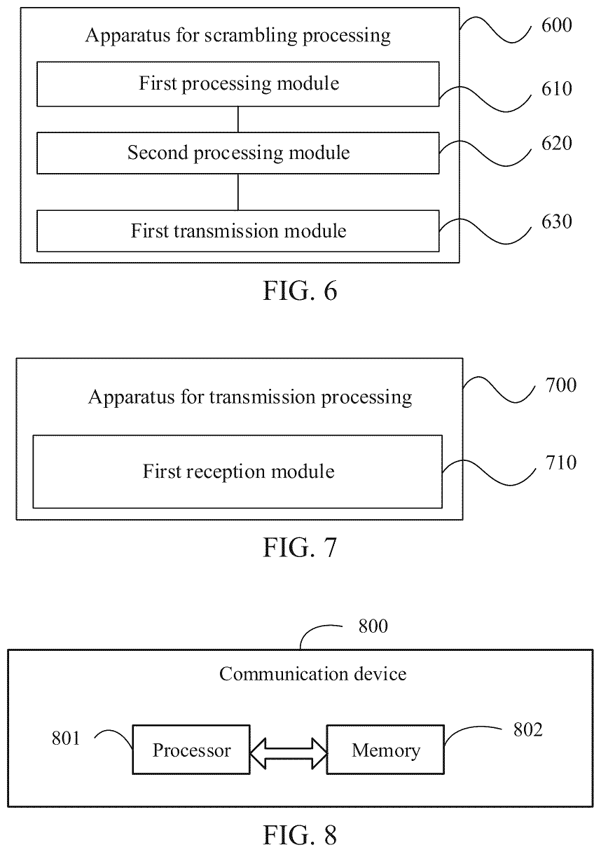

As shown in FIG. 6, an apparatus 600 for scrambling processing according to an embodiment of the present disclosure includes:
a first processing module 610 used for obtaining a scrambling sequence according to first information, where the first information is sensing-related information;
a second processing module 620 used for scrambling a first signal according to the scrambling sequence, and obtaining a second signal; and
a first transmission module 630 used for transmitting the second signal.

Optionally, the first information includes at least one of the following:
a sensing zone identity;
an identity indicating whether to be used for sensing;
a sensing service identity;
a sensing service type identity;
a sensing target identity;
a tag identity associated with a sensing target;
a sensing measurement quantity identity;
a device identity participating in sensing measurement;
a cell identity;
a time domain resource information;
a frequency domain resource information; and
a codeword number.

Optionally, the sensing zone identity is used for indicating at least one of the following:
a sensing zone composed of a plurality of base station coverage zones;
a sensing zone under a single base station coverage zone;
a sensing zone corresponding to a particular angle range of a single base station; and
a geographic zone identity.

Optionally, the time domain resource information includes at least one of the following:
a radio frame number, a sub-frame number, a slot number, a symbol number, duration, a time domain density, a cyclic prefix (CP) type, and a CP length; and
The frequency domain resource information includes at least one of the following:
a resource element (RE) index, a resource block (RB) index, frequency point information, frequency band information, a bandwidth, a frequency domain density, and a subcarrier spacing.

Optionally, an initial value of the scrambling sequence is associated with the first information.

Optionally, the step that the first signal is scrambled according to the scrambling sequence includes at least one of the following scrambling:
bit-level scrambling; and
symbol-level scrambling.

Optionally, the apparatus further includes:
a second transmission module configured to transmit the first information.

Optionally, the apparatus further includes:
a third transmission module configured to transmit a candidate set of the first information.

Optionally, the first signal includes at least one of the following:
a communication data bearing signal;
a reference signal;
a synchronization signal; and
a sensing-dedicated signal.

The apparatus generates the scrambling sequence according to the sensing-related information, then scrambles the first signal according to the scrambling sequence to obtain the second signal, and transmits the second signal. In this way, not only sensing-oriented interference is randomly distributed, but also the sensing-related information is carried by the second signal. Thus, a reception end may obtain the sensing-related information through detection, and signaling overhead may be reduced.

The apparatus for scrambling processing in the embodiment of the present disclosure may be an electronic device, and for example, an electronic device having an operating system, or may be a component in an electronic device, and for example, an integrated circuit or a chip. The electronic device may be a terminal, or may be another device except a terminal. For example, the terminal may include, but is not limited to, types of the terminal 11 listed above. Another device may be a server, a network attached storage (NAS), etc., and is not specifically limited by the embodiments of the present disclosure.

The apparatus for scrambling processing according to the embodiment of the present disclosure can implement all processes implemented in the method embodiments of FIG. 2, and achieve same technical effects. To avoid repetition, details will not be repeated herein.

An execution body of the method for transmission processing according to the embodiment of the present disclosure may be an apparatus for transmission processing. In the embodiment of the present disclosure, the apparatus for transmission processing according to the embodiment of the present disclosure is illustrated with a case of using the apparatus for scrambling processing to execute the method for transmission processing as an example.

As shown in FIG. 7, an apparatus 700 for transmission processing according to an embodiment of the present disclosure includes:
a first reception module 710 used for receiving a third signal.

The third signal is a second signal transmitted via a channel. The second signal is obtained by scrambling a first signal based on a scrambling sequence. The scrambling sequence is associated with a first information. The first information is sensing-related information.

Optionally, the first information includes at least one of the following:
a sensing zone identity;
an identity indicating whether to be used for sensing;
a sensing service identity;
a sensing service type identity;
a sensing target identity;
a tag identity associated with a sensing target;
a sensing measurement quantity identity;
a device identity participating in sensing measurement;
a cell identity;
a time domain resource information;
a frequency domain resource information; and
a codeword number.

Optionally, the sensing zone identity is used for indicating at least one of the following:
a sensing zone composed of a plurality of base station coverage zones;
a sensing zone under a single base station coverage zone;
a sensing zone corresponding to a particular angle range of a single base station; and
a geographic zone identity.

Optionally, the time domain resource information includes at least one of the following:
a radio frame number, a sub-frame number, a slot number, a symbol number, duration, a time domain density, a cyclic prefix (CP) type, and a CP length.

The frequency domain resource information includes at least one of the following:
a resource element (RE) index, a resource block (RB) index, frequency point information, frequency band information, a bandwidth, a frequency domain density, and a subcarrier spacing.

Optionally, an initial value of the scrambling sequence is associated with the first information.

Optionally, the apparatus further includes:
a third processing module configured to obtain the scrambling sequence according to the first information;
a fourth processing module configured to scramble the first signal according to the scrambling sequence, and obtain the second signal; and
a fifth processing module configured to obtain a sensing measurement result according to the second signal and the third signal.

Optionally, the apparatus further includes:
a sixth processing module configured to descramble and decode, in a case that the first signal is a communication data bearing signal, the third signal according to the scrambling sequence, and obtain the first signal.

Optionally, the apparatus further includes:
a second reception module configured to receive the first information; and
a seventh processing module configured to obtain a candidate set of the first information, and detect the third signal according to the candidate set, so as to determine the first information.

Optionally, the apparatus further includes:
a fourth transmission module configured to transmit, in a case that the third signal is detected according to the candidate set to obtain a detection result and the detection result does not satisfy a preset threshold or indicates a decoding error, a detection failure instruction to the first device.

The detection failure instruction is configured to instruct the first device to execute at least one of the following:
the second signal is retransmitted; and
the first information is transmitted.

Optionally, the apparatus further includes:
a third reception module configured to receive first configuration information. The first configuration information is configured to receive the third signal. The first configuration information includes at least one of the following:
a signal resource identity;
a waveform;
a subcarrier spacing;
a guard interval;
a time domain and/or frequency domain resource information;
a signal power;
a sequence information;
a signal direction; and
a quasi co-location relationship.

Optionally, the apparatus further includes:
a fourth reception module configured to receive a second configuration information. The second configuration information is used for performing sensing measurement and/or reporting a sensing measurement result. The second configuration information includes at least one of the following:
a sensing measurement quantity;
a time domain and/or frequency domain resource for reporting;
a reporting mode; and
a triggering condition for reporting.

The third signal received by the apparatus is a second signal transmitted via a channel. The second signal is obtained by scrambling the first signal based on the scrambling sequence. The scrambling sequence is associated with the first information. The first information is the sensing-related information. Thus, not only sensing-oriented interference is randomly distributed, but also the sensing-related information is carried by the second signal. In this way, a reception end may obtain the sensing-related information through detection, and signaling overhead may be reduced.

The apparatus for transmission processing in the embodiment of the present disclosure may be an electronic device, and for example, an electronic device having an operating system, or may be a component in an electronic device, and for example, an integrated circuit or a chip. The electronic device may be a terminal, or may be another device except a terminal. For example, the terminal may include, but is not limited to, types of the terminal 11 listed above. Another device may be a server, a network attached storage (NAS), etc., and is not specifically limited by the embodiments of the present disclosure.

The apparatus for transmission processing according to the embodiment of the present disclosure can implement all processes implemented in the method embodiments of FIG. 5, and achieve same technical effects. To avoid repetition, details will not be repeated herein.

Optionally, as shown in FIG. 8, an embodiment of the present disclosure further provides a communication device 800. The communication device includes a processor 801 and a memory 802. The memory 802 stores programs or instructions runnable on the processor 801. For example, when the communication device 800 is a first device and the programs or the instructions are executed by the processor 801, all steps of the embodiments of the method for scrambling processing are implemented, and same technical effects can be achieved. When the communication device 800 is a second device and the programs or the instructions are executed by the processor 801, all steps of the embodiments of the method for transmission processing are implemented, and same technical effects can be achieved. To avoid repetition, details will not be repeated herein.

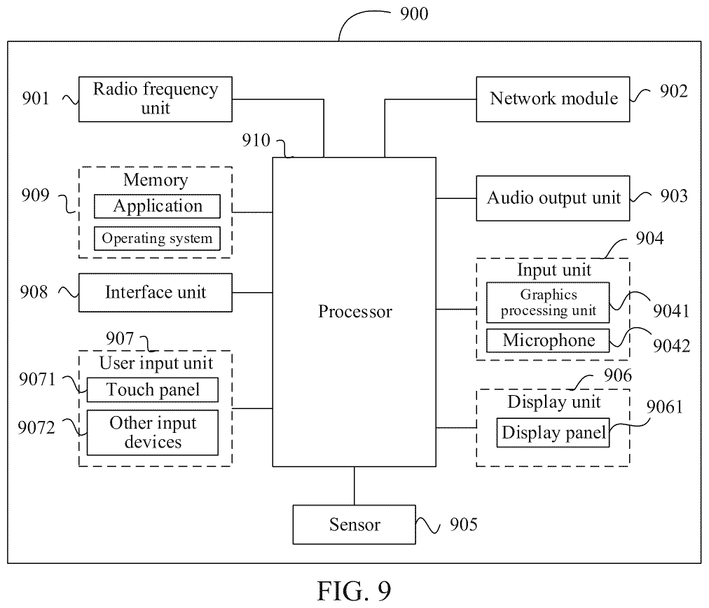

An embodiment of the present disclosure further provides a communication device. The communication device includes a processor and a communication interface. The processor is configured to obtain a scrambling sequence according to a first information, where the first information is sensing-related information; and scramble a first signal according to the scrambling sequence, and obtaining a second signal. The communication interface is configured to transmit the second signal. The embodiment of the communication device corresponds to the method embodiment at the first device side. Various implementation processes and implementations of the method embodiment may be all applied to the embodiments of the communication device and can achieve same technical effects. Specifically, FIG. 9 is a schematic structural diagram of hardware for implementing an embodiment of the present disclosure as a terminal of a first device.

The terminal 900 includes, but is not limited to, at least some of components such as a radio frequency unit 901, a network module 902, an audio output unit 903, an input unit 904, a sensor 905, a display unit 906, a user input unit 907, an interface unit 908, a memory 909, and a processor 910.

Those skilled in the art can understand that the terminal 900 may further include a power supply (for example, a battery) for supplying power to all components, and the power supply may be logically connected to the processor 910 through a power management system, such that functions such as charging, discharging, and power consumption management are achieved through the power management system. A terminal structure shown in FIG. 9 does not limit the terminal. The terminal may include more or fewer components than those shown in the figure, combine some components, or have different component arrangements, which will not be repeated herein.

It should be understood that, in the embodiment of the present disclosure, the input unit 904 may include a graphics processing unit (GPU) 9041 and a microphone 9042. The graphics processing unit 9041 processes image data of a static picture or a video obtained by an image capture apparatus (for example, a camera) in a video capture mode or an image capture mode. The display unit 906 may include a display panel 9061. The display panel 9061 may be configured in a form of a liquid crystal display, an organic light-emitting diode, etc. The user input unit 907 includes a touch panel 9071 and at least one of other input devices 9072. The touch panel 9071 is referred to as a touchscreen. The touch panel 9071 may include two parts: a touch sensing apparatus and a touch controller. The other input devices 9072 may include, but are not limited to, a physical keyboard, a functional key (for example, a volume control key or a switch key), a track ball, a mouse, and a joystick, which will not be repeated herein.

In the embodiment of the present disclosure, after the radio frequency unit 901 receives downlink data from a network side device, the data may be transmitted to the processor 910 for processing. In addition, the radio frequency unit 901 may transmit uplink data to the network side device. Generally, the radio frequency unit 901 includes, but is not limited to, an antenna, an amplifier, a transceiver, a coupler, a low noise amplifier, a duplexer, etc.

The memory 909 may be configured to store software programs or instructions and various data. The memory 909 may mainly include a first storage zone for storing the programs or the instructions and a second storage zone for storing data. The first storage zone may store an operating system, an application or an instruction required by at least one function (for example, a sound playback function and an image display function), etc. In addition, the memory 909 may be a volatile memory or a non-volatile memory, or the memory 909 may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), and a direct Rambus random access memory (DRRAM). The memory 909 in the embodiment of the present disclosure includes, but is not limited to, the memories and any other suitable types of memories.

The processor 910 may include one or more processing units. Optionally, the processor 910 integrates an application processor and a modem processor. The application processor mainly processes operations relating to an operating system, a user interface, an application, etc., and the modem processor, such as a baseband processor, mainly processes a radio communication signal. It may be understood that the modem processor may alternatively not be integrated into the processor 910.

The processor 910 is configured to obtain a scrambling sequence according to a first information, where the first information is sensing-related information; and scramble a first signal according to the scrambling sequence, and obtain a second signal.

The radio frequency unit 901 is configured to transmit the second signal.

Optionally, the first information includes at least one of the following:
a sensing zone identity;
an identity indicating whether to be used for sensing;
a sensing service identity;
a sensing service type identity;
a sensing target identity;
a tag identity associated with a sensing target;
a sensing measurement quantity identity;
a device identity participating in sensing measurement;
a cell identity;
a time domain resource information;
a frequency domain resource information; and
a codeword number.

Optionally, the sensing zone identity is used for indicating at least one of the following:
a sensing zone composed of a plurality of base station coverage zones;
a sensing zone under a single base station coverage zone;
a sensing zone corresponding to a particular angle range of a single base station; and
a geographic zone identity.

Optionally, the time domain resource information includes at least one of the following:
a radio frame number, a sub-frame number, a slot number, a symbol number, duration, a time domain density, a cyclic prefix (CP) type, and a CP length.

The frequency domain resource information includes at least one of the following:
a resource element (RE) index, a resource block (RB) index, frequency point information, frequency band information, a bandwidth, a frequency domain density, and a subcarrier spacing.

Optionally, an initial value of the scrambling sequence is associated with the first information.

Optionally, the step that the first signal is scrambled according to the scrambling sequence includes at least one of the following scrambling:
bit-level scrambling; and
symbol-level scrambling.

Optionally, the radio frequency unit 901 is further configured to transmit the first information.

Optionally, the radio frequency unit 901 is further configured to transmit a candidate set of the first information.

Optionally, the first signal includes at least one of the following:
a communication data bearing signal;
a reference signal;
a synchronization signal; and
a sensing-dedicated signal.

The terminal generates the scrambling sequence according to the sensing-related information, then scrambles the first signal according to the scrambling sequence to obtain the second signal, and transmits the second signal. In this way, not only sensing-oriented interference is randomly distributed, but also the sensing-related information is carried by the second signal. Thus, a reception end may obtain the sensing-related information through detection, and signaling overhead may be reduced.

An embodiment of the present disclosure further provides a communication device. The communication device includes a processor and a communication interface. The communication interface is configured to receive a third signal. The third signal is a second signal transmitted via a channel. The second signal is obtained by scrambling a first signal based on a scrambling sequence. The scrambling sequence is associated with a first information. The first information is sensing-related information. The embodiment of the communication device corresponds to the method embodiment at the second device side. Various implementation processes and implementations of the method embodiment may be all applied to the embodiments of the communication device and can achieve same technical effects. Specifically, FIG. 9 is a schematic structural diagram of hardware for implementing an embodiment of the present disclosure as a terminal of a second device. A structure of the terminal is described as the above description, and will not be repeated herein.

A radio frequency unit 901 is configured to receive a third signal.

The third signal is a second signal transmitted via a channel. The second signal is obtained by scrambling first signal based on a scrambling sequence. The scrambling sequence is associated with a first information. The first information is sensing-related information.

Optionally, the first information includes at least one of the following:
a sensing zone identity;
an identity indicating whether to be used for sensing;
a sensing service identity;
a sensing service type identity;
a sensing target identity;
a tag identity associated with a sensing target;
a sensing measurement quantity identity;
a device identity participating in sensing measurement;
a cell identity;
a time domain resource information;
a frequency domain resource information; and
a codeword number.

Optionally, the sensing zone identity is used for indicating at least one of the following:
a sensing zone composed of a plurality of base station coverage zones;
a sensing zone under a single base station coverage zone;
a sensing zone corresponding to a particular angle range of a single base station; and
a geographic zone identity.

Optionally, the time domain resource information includes at least one of the following:
a radio frame number, a sub-frame number, a slot number, a symbol number, duration, a time domain density, a cyclic prefix (CP) type, and a CP length.

The frequency domain resource information includes at least one of the following:
a resource element (RE) index, a resource block (RB) index, frequency point information, frequency band information, a bandwidth, a frequency domain density, and a subcarrier spacing.

Optionally, an initial value of the scrambling sequence is associated with the first information.

Optionally, a processor 910 is configured to:
obtain the scrambling sequence according to the first information;
scramble the first signal according to the scrambling sequence, and obtain the second signal; and
A sensing measurement result is obtained according to the second signal and the third signal.

Optionally, the processor 910 is further configured to:
descramble and decode, in a case that the first signal is a communication data bearing signal, the third signal according to the scrambling sequence, and obtain the first signal.

Optionally, the radio frequency unit 901 is further configured to receive the first information; and
the processor 910 is further configured to obtain the candidate set of the first information, and detect the third signal according to the candidate set, so as to determine the first information.

Optionally, the radio frequency unit 901 is further configured to transmit, in a case that the third signal is detected according to the candidate set to obtain a detection result and the detection result does not satisfy a preset threshold or indicates a decoding error, a detection failure instruction to the first device.

The detection failure instruction is used for instructing the first device to execute at least one of the following:
the second signal is retransmitted; and
the first information is transmitted.

Optionally, the radio frequency unit 901 is further configured to receive first configuration information. The first configuration information is used for receiving the third signal. The first configuration information includes at least one of the following:
a signal resource identity;
a waveform;
a subcarrier spacing;
a guard interval;
a time domain and/or frequency domain resource information;
a signal power;
a sequence information;
a signal direction; and
a quasi co-location relationship.

Optionally, the radio frequency unit 901 is further configured to receive a second configuration information. The second configuration information is used for performing sensing measurement and/or reporting a sensing measurement result. The second configuration information includes at least one of the following:
a sensing measurement quantity;
a time domain and/or frequency domain resource for reporting;
a reporting mode; and
a triggering condition for reporting.

The third signal received by the terminal is a second signal transmitted via a channel. The second signal is obtained by scrambling the first signal based on the scrambling sequence. The scrambling sequence is associated with the first information. The first information is the sensing-related information. Thus, not only sensing-oriented interference is randomly distributed, but also the sensing-related information is carried by the second signal. In this way, a reception end may obtain the sensing-related information through detection, and signaling overhead may be reduced.

An embodiment of the present disclosure further provides a network side device. The network side device includes a processor and a communication interface. The embodiment of the network side device corresponds to the method embodiment of the first device or the second device. Various implementation processes and implementations of the method embodiment may be all applied to the embodiment of the network side device and can achieve same technical effects.

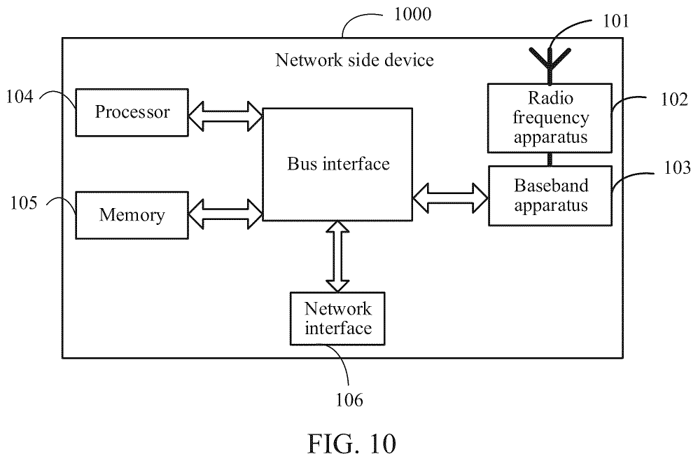

Specifically, an embodiment of the present disclosure further provides a network side device. As shown in FIG. 10, the network side device 1000 includes: an antenna 101, a radio frequency apparatus 102, a baseband apparatus 103, a processor 104, and a memory 105. The antenna 101 is connected to the radio frequency apparatus 102. In an uplink direction, the radio frequency apparatus 102 receives information through the antenna 101, and transmits the received information to the baseband apparatus 103 for processing. In a downlink direction, the baseband apparatus 103 processes to-be-transmitted information, and transmits the information to the radio frequency apparatus 102. The radio frequency apparatus 102 processes the received information and then transmits the information through the antenna 101.

In the embodiment, the method executed by the first device or the second device may be implemented in the baseband apparatus 103. The baseband apparatus 103 includes a baseband processor.

The baseband apparatus 103 may include, for example, at least one baseband board. The baseband board is provided with a plurality of chips. As shown in FIG. 10, one of the chips is a baseband processor for example, and is connected to the memory 105 through a bus interface, such that programs in the memory 105 are invoked to execute operations of the network device shown in the method embodiment.

The network side device may further include a network interface 106. The interface is, for example, a common public radio interface (CPRI).

Specifically, the network side device 1000 of the embodiment of the present disclosure further includes: instructions or programs stored in the memory 105 and runnable on the processor 104. The processor 104 invokes the instructions or the programs in the memory 105 to execute the method executed by each module shown in FIG. 6 or FIG. 7, and achieves a same technical effect. To avoid repetition, details will not be repeated herein.

An embodiment of the present disclosure further provides a readable storage medium. The readable storage medium stores programs or instructions. When the programs or the instructions are executed by a processor, all processes of the embodiment of the method for scrambling processing or the method for transmission processing are implemented, and same technical effects can be achieved. To avoid repetition, details will not be repeated herein.

The processor is a processor of the terminal of the embodiment. The readable storage medium includes a computer-readable storage medium, such as a computer read-only memory (ROM), a random access memory (RAM), a magnetic disk, or an optical disk.

An embodiment of the present disclosure further provides a chip. The chip includes a processor and a communication interface. The communication interface is coupled to the processor. The processor is used for running programs or instructions, such that all processes of the embodiment of the method for scrambling processing or the method for transmission processing are implemented, and same technical effects can be achieved. To avoid repetition, details will not be repeated herein.

It should be understood that the chip mentioned in the embodiment of the present disclosure may alternatively be referred to as a system on a chip, a system chip, a chip system, a system-on-chip, etc.

An embodiment of the present disclosure further provides a computer program/program product. The computer program/program product is stored in a storage medium. The computer program/program product is executed by at least one processor, such that all processes of the embodiment of the method for scrambling processing or the method for transmission processing are implemented, and same technical effects can be achieved. To avoid repetition, details will not be repeated herein.

An embodiment of the present disclosure further provides a communication system. The communication system includes: a first device and a second device. The first device may be configured to execute steps of the method for scrambling processing. The second device may be configured to execute steps of the method for transmission processing.

It should be noted that terms “include”, “comprise”, “involve”, or their any other variations herein are intended to cover non-exclusive inclusions, such that a process, a method, an article, or an apparatus including a series of elements not only includes those elements, but also includes other elements that are not explicitly listed, or includes inherent elements of the process, the method, the article, or the apparatus. Without more restrictions, the elements defined by the sentence “include a . . . ” or “comprise a . . . ” do not exclude existence of other identical elements in the process, the method, the article, or the apparatus including the elements. In addition, it should be noted that a range of the method and the apparatus in an implementation of the present disclosure is not restricted to execution of functions in order shown or discussed, and may further include execution of functions involved in a substantially simultaneous manner or in reverse order. For example, the method described may be executed in order different from that described, and various steps may be added, omitted, or combined. Moreover, features described with reference to some examples may be combined in other examples.

From description of the implementation, those skilled in the art may clearly understand that the methods of the embodiments may be implemented through software plus a necessary general-purpose hardware platform, or hardware. In many cases, the former is a better implementation. With such understanding, the technical solution of the present disclosure, in essence or from the view of part contributing to the related art, may be embodied in a form of a computer software product. The computer software product is stored in a storage medium (such as an ROM/RAM, a magnetic disk, and an optical disk) and includes several instructions used for enabling a terminal (which may be a mobile phone, a computer, a server, an air conditioner, a network device, etc.) to execute the method according to each embodiment of the present disclosure.

The embodiments of the present disclosure are described above with reference to the accompanying drawings, but the present disclosure is not restricted to the above specific implementations. The specific implementations are merely illustrative rather than restrictive. Inspired by the present disclosure, those of ordinary skill in the art may still make many forms without departing from the essence of the present disclosure and the protection scope of the claims, which all fall within the protection scope of the present disclosure.

1. A method for scrambling processing, comprising:
obtaining, by a first device, a scrambling sequence according to a first information, wherein the first information is sensing-related information;
scrambling, by the first device, the first signal according to the scrambling sequence, and obtaining a second signal; and
transmitting the second signal by the first device.

2. The method according to claim 1, wherein the first information comprises at least one of the following:
a sensing zone identity;
an identity indicating whether to be used for sensing;
a sensing service identity;
a sensing service type identity;
a sensing target identity;
a tag identity associated with a sensing target;
a sensing measurement quantity identity;
a device identity participating in sensing measurement;
a cell identity;
a time domain resource information;
a frequency domain resource information; or
a codeword number.

3. The method according to claim 2, wherein the sensing zone identity is used for indicating at least one of the following:
a sensing zone composed of a plurality of base station coverage zones;
a sensing zone under a single base station coverage zone;
a sensing zone corresponding to a particular angle range of a single base station; or
a geographic zone identity.

4. The method according to claim 2, wherein the time domain resource information comprises at least one of the following:
a radio frame number, a sub-frame number, a slot number, a symbol number, duration, a time domain density, a cyclic prefix (CP) type, and a CP length; or
the frequency domain resource information comprises at least one of the following:
a resource element (RE) index, a resource block (RB) index, a frequency point information, a frequency band information, a bandwidth, a frequency domain density, or a subcarrier spacing.

5. The method according to claim 1, wherein an initial value of the scrambling sequence is associated with the first information.

6. The method according to claim 1, wherein the scrambling, by the first device, the first signal according to the scrambling sequence comprises at least one of the following scrambling:
bit-level scrambling; or
symbol-level scrambling.

7. The method according to claim 1, further comprising:
transmitting the first information by the first device.

8. The method according to claim 1, further comprising:
transmitting a candidate set of the first information by the first device.

9. The method according to claim 1, the first signal comprises at least one of the following:
a communication data bearing signal;
a reference signal;
a synchronization signal; or
a sensing-dedicated signal.

10. The method according to claim 1, the first device comprises a base station or a terminal.

11. A method for transmission processing, comprising:
receiving a third signal by a second device, wherein
the third signal is a second signal transmitted via a channel, the second signal is obtained by scrambling a first signal based on a scrambling sequence, the scrambling sequence is associated with a first information, and the first information is sensing-related information.

12. The method according to claim 11, wherein the first information comprises at least one of the following:
a sensing zone identity;
an identity indicating whether to be used for sensing;
a sensing service identity;
a sensing service type identity;
a sensing target identity;
a tag identity associated with a sensing target;
a sensing measurement quantity identity;
a device identity participating in sensing measurement;
a cell identity;
a time domain resource information;
a frequency domain resource information; or
a codeword number;
and/or,
wherein an initial value of the scrambling sequence is associated with the first information.

13. The method according to claim 11, wherein after the receiving a third signal by a second device, the method further comprises:
obtaining, by the second device, the scrambling sequence according to the first information;
scrambling, by the second device, the first signal according to the scrambling sequence, and obtaining the second signal; and
obtaining, by the second device, a sensing measurement result according to the second signal and the third signal.

14. The method according to claim 13, wherein before the scrambling, by the second device, the first signal according to the scrambling sequence, the method further comprises:
descrambling and decoding, in a case that the first signal is a communication data bearing signal, the third signal by the second device according to the scrambling sequence, and obtaining the first signal.

15. The method according to claim 13, wherein before the obtaining, by the second device, the scrambling sequence according to the first information, the method further comprises:
receiving the first information by the second device; or,
obtaining, by the second device, a candidate set of the first information, and detecting the third signal according to the candidate set, so as to determine the first information.

16. The method according to claim 15, further comprising:
transmitting, in a case that the third signal is detected according to the candidate set to obtain a detection result and the detection result does not satisfy a preset threshold or indicates a decoding error, a detection failure instruction to the first device by the second device, wherein
the detection failure instruction is used for instructing the first device to execute at least one of the following:
retransmitting the second signal; or
transmitting the first information.

17. The method according to claim 11, wherein before the receiving a third signal by a second device, the method further comprises:
receiving a first configuration information by the second device, wherein the first configuration information is used for receiving the third signal, and the first configuration information comprises at least one of the following:
a signal resource identity;
a waveform;
a subcarrier spacing;
a guard interval;
a time domain and/or frequency domain resource information;
a signal power;
a sequence information;
a signal direction; or
a quasi co-location relationship;
or,
wherein the method further comprises:
receiving a second configuration information by the second device, wherein the second configuration information is used for performing sensing measurement and/or reporting a sensing measurement result, and the second configuration information comprises at least one of the following:
a sensing measurement quantity;
a time domain and/or frequency domain resource for reporting;
a reporting mode; or
a triggering condition for reporting.

18. The method according to claim 11, wherein the second device comprises a base station or a terminal.

19. A communication device, comprising a processor and a memory, wherein the memory stores programs or instructions runnable on the processor, wherein the programs or the instructions, when executed by the processor, cause the processor to perform:
obtaining a scrambling sequence according to a first information, wherein the first information is sensing-related information;
scrambling the first signal according to the scrambling sequence, and obtaining a second signal; and
transmitting the second signal.

20. A communication device, comprising a processor and a memory, wherein the memory stores programs or instructions runnable on the processor, and when the programs or the instructions are executed by the processor, steps of the method for transmission processing according to claim 11 are implemented.
